(19) United States
(12) Patent Application Publication
(10) Pub. No.: US 2025/0117818 A1
(43) Pub. Date: Apr. 10, 2025

(54) TRAFFIC DEMAND PREDICTION DEVICE

(71) Applicant: NTT DOCOMO, INC., Tokyo (JP)

(72) Inventors: Yusuke NAKAMURA, Chiyoda-ku (JP); Takashi SUZUKI, Chiyoda-ku (JP); Akira YAMADA, Chiyoda-ku (JP)

(73) Assignee: NTT DOCOMO, INC., Tokyo (JP)

(21) Appl. No.: 18/730,053

(22) PCT Filed: Feb. 8, 2023
(86) PCT No.: PCT/JP2023/004263

§ 371 Date: Jul. 18, 2024

(30) Foreign Application Priority Data
Apr. 4, 2022 (JP) 2022-062274

(51) Int. Cl. G06Q 30/0202; G06Q 10/047

(52) U.S. Cl. CPC G06Q 30/0202; G06Q 10/047

(57) ABSTRACT

A traffic demand prediction device (10) includes: a depot headcount prediction unit (10A) that predicts a number of people per depot in an area from a predicted number of people obtained in advance for each of areas including at least one of a departure area and a return area of visitors to a target event based on at least a numerical value regarding a scale of use of each depot in each area obtained in advance; a route headcount prediction unit (13) that predicts a number of people per route between each depot in an area obtained by a route search algorithm and an event nearest depot from the obtained number of people per depot in the area; and a use headcount prediction unit (14) that predicts a number of users per event nearest depot or per nearest rout based on the obtained number of people per route.

### TECHNICAL FIELD

The present disclosure relates to a traffic demand prediction device that predicts traffic demand associated with holding of various events, functions, performances, and the like (hereinafter, collectively referred to as an “event”).

Hereinafter, a “return area” of a visitor to a certain event means an area to which the visitor has moved from an event venue immediately after the event and has initially stayed. For example, in a case where a visitor has gone straight home immediately after an event, an area around the home is a return area, and in a case where a visitor has stopped at a commercial facility immediately after an event, an area around the commercial facility is a return area. Similarly, a “departure area” of a visitor to a certain event means an area where the visitor has stayed immediately before moving to an event venue immediately before the event. For example, in a case where a visitor has moved straight from home to an event venue, an area around the home is a departure area, and in a case where a visitor has stopped at a commercial facility immediately before an event, an area around the commercial facility is a departure area. Areas including at least one of a “return area” and a “departure area” of a visitor to a certain event are collectively referred to as an “area”.

### BACKGROUND ART

In planning to hold various events, for the purpose of examination of measures of traffic improvement to an event venue, article sales marketing, or the like, it is important to predict in advance a traffic demand associated with holding of various events. For events with a long history of having been held, information on approximately how many people went toward each of the nearest stations to an event venue immediately after the end is accumulated as know-how. Thus, measures such as traffic guidance can be drafted roughly. For example, Patent Literature 1 discloses a technique that obtains an increase proportion in a number of people who alight at a nearest station before the start of an event on the day of the event compared to a number of people who have alighted from the same station on a day that the event has not been held, and predicts a number of people who will use the nearest station immediately after the end of the event, or the like based on the obtained proportion and the like.

### CITATION LIST

### Patent Literature

[Patent Literature 1] Japanese Unexamined Patent Publication No. 2015-219673

### SUMMARY OF INVENTION

### Technical Problem

On the other hand, for events at newly opened event venues, it has been difficult to conceive of measures such as traffic control, because it has not been clear approximately how many people would go toward each of the nearest stations to the event venue immediately after the event end. Furthermore, even for events with a long history of having been held, there is a limit to improving prediction accuracy of traffic demand merely by using know-how accumulated in the past.

The present disclosure has been accomplished to solve the above-described problem, and an object of the present disclosure is to predict traffic demand associated with holding of various events with excellent accuracy.

### Solution to Problem

A traffic demand prediction device according to the present disclosure includes: a depot headcount prediction unit configured to predict a number of people per depot in an area from a predicted number of people obtained in advance for each of areas including at least one of a departure area and a return area of visitors to a target event based on at least a numerical value regarding a scale of use of each of depots in each of areas obtained in advance; a route headcount prediction unit configured to predict a number of people per route between each depot in an area obtained by a route search algorithm and an event nearest depot from the number of people per depot in the area obtained by prediction in the depot headcount prediction unit; and a use headcount prediction unit configured to predict a number of users per event nearest depot or per nearest route based on the number of people per route obtained by prediction in the route headcount prediction unit.

In the above-described traffic demand prediction device, the depot headcount prediction unit predicts a number of people per depot in the area from a predicted number of people for each area pertaining to the visitors of the target event based on at least the numerical value (for example, the average number of boarding people per day at each station) regarding the scale of use of each of the depots in each area, and the route headcount prediction unit predicts a number of people per route between each depot in the area obtained by the route search algorithm and the event nearest depot from the number of people per depot in the area obtained by prediction. Then, the use headcount prediction unit predicts a number of users per event nearest depot or per nearest route based on the number of people per route obtained by prediction. For example, the number of users of the event nearest depot is predicted by obtaining the total of the number of people per route regarding all routes to a certain event nearest depot, and it is possible to predict the number of users per event nearest depot by performing such prediction on all event nearest depots.

As above, it is possible to predict the number of users per event nearest depot or per nearest route from the predicted number of people for each area pertaining to the visitors of the target event obtained in advance without using know-how of approximately how many people went toward each of the nearest stations to the event venue immediately after the end. With this, for example, even for events at newly opened event venues or new events, it is possible to predict the number of users per event nearest depot or per nearest route with excellent accuracy. Furthermore, even for events with a long history of having been held, it is possible to predict the number of users per event nearest depot or per nearest route with excellent accuracy according to the predicted number of people for each area pertaining to the visitors of the target event. That is, it is possible to predict traffic demand associated with holding of various events with excellent accuracy.

### Advantageous Effects of Invention

According to the present disclosure, it is possible to predict traffic demand associated with holding of various events with excellent accuracy.

### BRIEF DESCRIPTION OF DRAWINGS

FIG. 1 is a functional block configuration diagram of a traffic demand prediction device according to an embodiment of the invention and related devices.

FIG. 2 is a flowchart illustrating processing that is executed in the traffic demand prediction device.

FIG. 3 is a diagram illustrating processing by a headcount distribution unit.

FIG. 4 is a diagram illustrating an output data example from a route headcount prediction unit.

FIG. 5(a) is a diagram illustrating an output data example of a number of users per event nearest station, and FIG. 5(b) is a diagram illustrating an output data example of a number of users per each nearest route.

FIG. 6 is a diagram illustrating various examples of a numerical value regarding a scale of use of each of depots in each area.

FIG. 7 is a diagram illustrating a hardware configuration example of the traffic demand prediction device.

### DESCRIPTION OF EMBODIMENTS

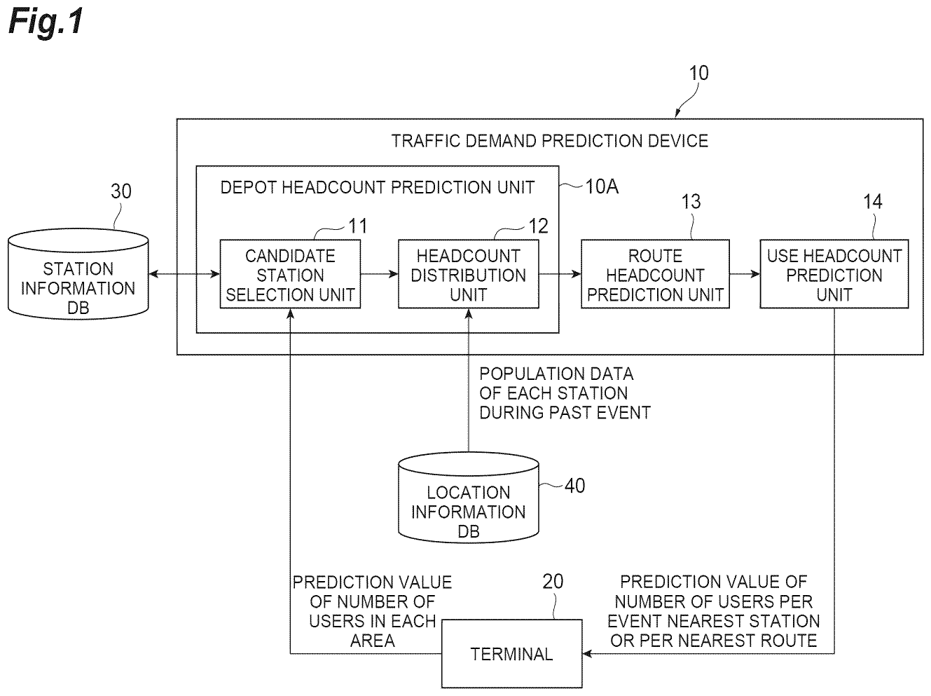

An embodiment of a traffic demand prediction device according to the present disclosure will be described with reference to the drawings. As illustrated in FIG. 1, a traffic demand prediction device 10 includes a depot headcount prediction unit 10A, a route headcount prediction unit 13, and a use headcount prediction unit 14. Hereinafter, the function of each unit will be schematically described. While a route pertaining to traffic demand includes all sorts of routes such as railway routes and bus routes which are operated to allow stopping at predetermined depots (stations or bus stops) along a predetermined route, in the following embodiment, a railway route is assumed as a route pertaining to traffic demand, and a station is assumed as a depot.

The depot headcount prediction unit 10A is a functional unit that predicts a number of people per station in an area from the predicted number of people obtained in advance for each of areas (areas including at least one of a departure area and a return area) of visitors of a target event based on at least a numerical value (for example, the average number of boarding people per day at each station) regarding a scale of use of each of stations in each area obtained in advance. To exert the above-described function, the depot headcount prediction unit 10A includes a candidate station selection unit 11 and a headcount distribution unit 12.

Of these, the candidate station selection unit 11 acquires a prediction value of a number of users in each area obtained in advance, from a terminal 20, and refers to a station information database (DB) 30 to extract a station to be a candidate in each area. In FIG. 1, while an example where the station information DB 30 is provided outside the traffic demand prediction device 10 is illustrated, the station information DB 30 may be provided inside the traffic demand prediction device 10.

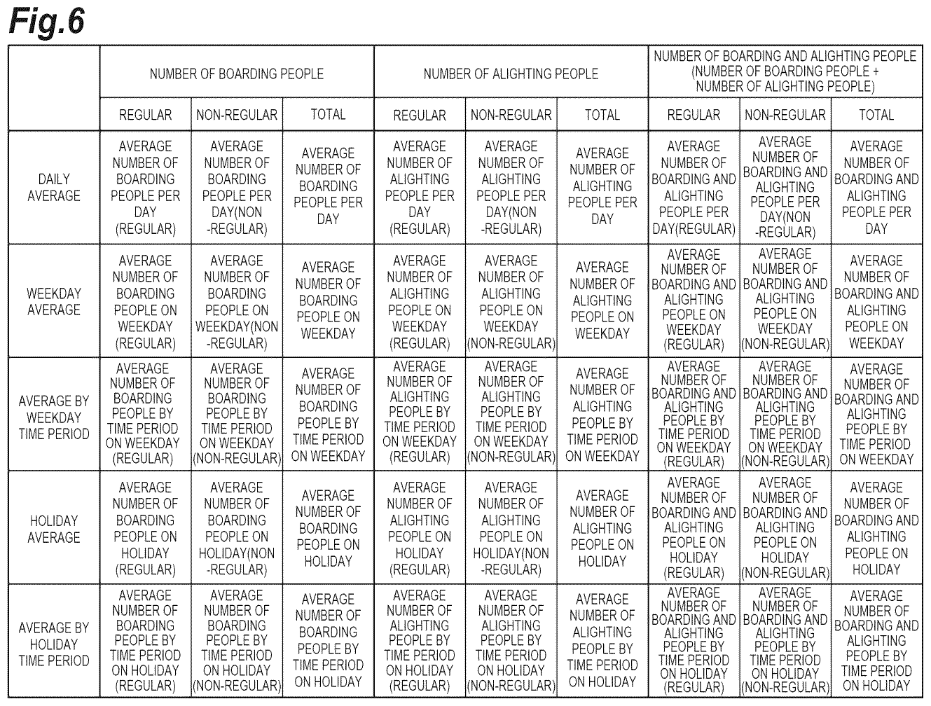

The headcount distribution unit 12 predicts a number of people at each station in an area by distributing the prediction value of the number of users in each area into the numbers of people at the respective stations in the area based only on the numerical value (for example, the average number of boarding people per day at each station) regarding the scale of use of each of the stations in each area obtained in advance or based on population data at each station during a past event capable of being acquired from a location information database (DB) 40 in addition to the numerical value regarding the scale of use of each of the stations in each area. Details will be described below. As the numerical value regarding the scale of use of each of the stations in each area, the numbers of people of multiple patterns illustrated in FIG. 6 other than the average number of boarding people per day at each station may be employed. That is, as “a way of taking an average” illustrated in a longitudinal direction in a table of FIG. 6, there are variations such as daily average, weekday average, . . . , and average by time period on holiday. On the other hand, as “target number of people” illustrated in the longitudinal direction in the table of FIG. 6, there are variations such as a number of boarding people, a number of alighting people, and a number of boarding and alighting people (the total of the number of boarding people and the number of alighting people). In addition, in each variation, there are sub-variations of “regular” where a commuter ticket is used, “non-regular” where a commuter ticket is not used, and “total” that is the total of regular and non-regular. For this reason, it is possible to employ many patterns of people as there are combinations of the variations in the longitudinal direction and the variations in the transverse direction in the table of FIG. 6.

Returning to FIG. 1, the route headcount prediction unit 13 in the traffic demand prediction device 10 is a functional unit that predicts a number of people per route between each station in the area obtained by a route search algorithm and an event nearest station from the number of people at each station in the area obtained by prediction in the headcount distribution unit 12. As the above-described route search algorithm, an algorithm that performs route search based on not only geographical route map information but also operation information along a time axis and a priority matter in the route search is employed. Details will be described below.

The use headcount prediction unit 14 is a functional unit that predicts a number of users per event nearest station or per nearest route based on the number of people per route obtained by prediction in the route headcount prediction unit 13, and details will be described below.

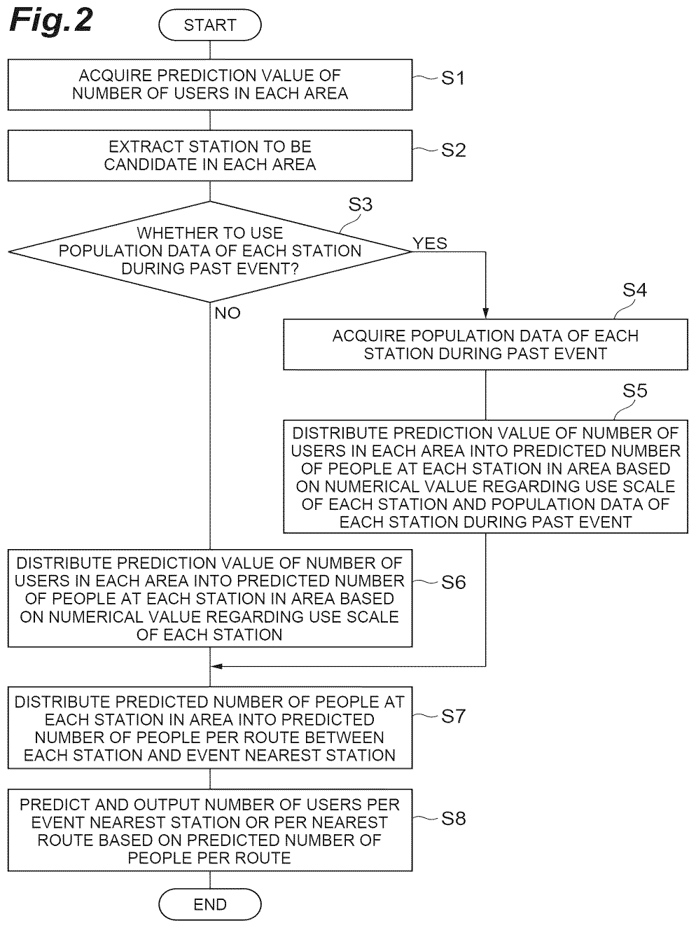

Next, processing that is executed in the traffic demand prediction device 10 will be described along a flowchart of FIG. 2. For example, the processing of FIG. 2 starts to be executed, for example, with reception of an execution start command in the traffic demand prediction device 10 along with a prediction value of a number of users in each area obtained in advance from the terminal 20 as a trigger. First, the candidate station selection unit 11 acquires the prediction value of the number of users in each area from the terminal 20 (Step S1), and refers to the station information DB 30 to extract a station to be a candidate in each area (Step S2). Note that the processing order of Steps S1 and S2 needs not necessarily be the order of FIG. 2, and may be reversed, or the steps may be executed in parallel at the same time. If a station to be a candidate in each area is extracted in the past, and information regarding a candidate station of each area is stored in the traffic demand prediction device 10, the processing of Step S2 does not need to be executed every time.

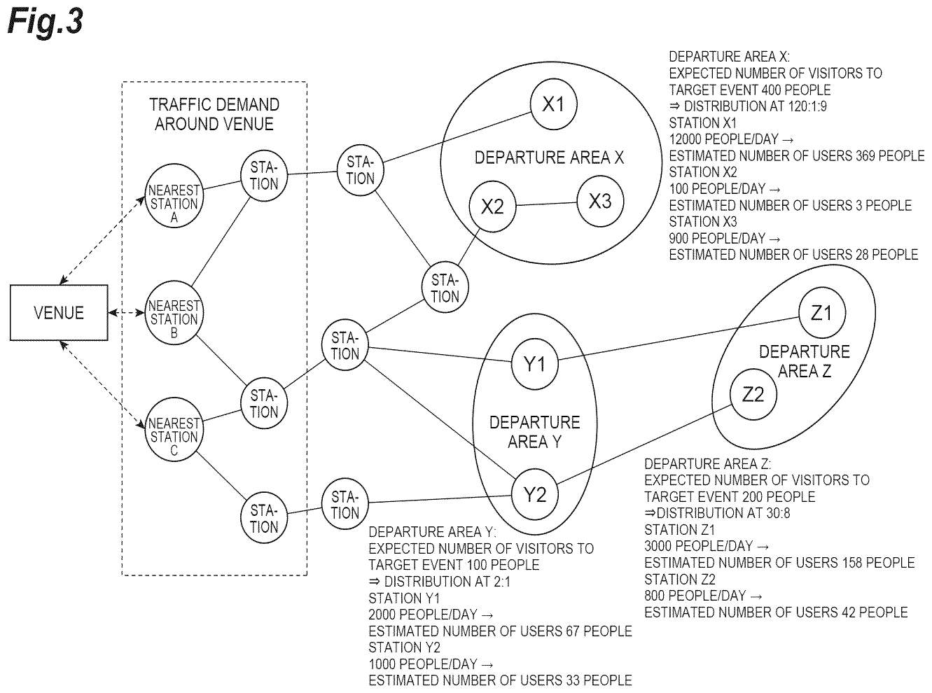

Next, the headcount distribution unit 12 determines whether or not to use population data at each station during a past event (Step S3). The determination may be performed, for example, based on a parameter regarding “whether or not to use past population data” designated by a user in the execution start command from the terminal 20. In a case where determination is made not to use past population data in Step S3, the headcount distribution unit 12 distributes the prediction value of the number of users in each area into the predicted numbers of people at the respective stations in the area based on the numerical value (for example, the average number of boarding people per day at each station) regarding the scale of use of each of the stations (Step S6). For example, in a case where the expected number of visitors to a target event in a departure area X illustrated in FIG. 3 is 400 people, and the average numbers of boarding people per day at respective candidate stations X1 to X3 in the departure area X are 12000 people/day, 100 people/day, and 900 people/day, the above-described expected number of visitors of 400 people is distributed at a ratio (120:1:9), and the estimated numbers of users at the respective candidate stations X1 to X3 are obtained as 369 people, 3 people, and 28 people. Similarly, the expected number of visitors of 100 people to the target event in the departure area Y is distributed at a ratio (2:1) of the average numbers of boarding people per day at respective candidate stations Y1 and Y2 in the departure area Y, so that the estimated numbers of users at the respective candidate stations Y1 and Y2 are obtained as 67 people and 33 people. The expected number of visitors of 200 people to the target event in a departure area Z is distributed at a ratio (30:8) of the average numbers of boarding people per day at respective candidate stations Z1 and Z2 in the departure area Z, so that the estimated numbers of users at the respective candidate stations Z1 and Z2 are obtained as 158 people and 42 people. Here, while an example where “departure area” out of “return area” and “departure area” of visitors to a certain event has been focused has been illustrated, “return area” may be focused upon or both “return area” and “departure area” may be focused upon.

The distribution in Step S6 as above is represented, for example, by the following expression. In a case where n candidate stations are included in any area, the average numbers of boarding people per day at the respective stations are denoted as s^{m}₁, s^{m}₂, . . . , s^{m}ₙ, and the prediction value of the number of visitors in the area is N people, the estimated numbers of event visitors s^{e}₁, s^{e}₂, . . . , and s^{e}ₙ at the respective stations are obtained by Equation (1) described below.

$$[ Equation 1 ]$$

$${s}_{i}^{e} = \frac{{s}_{i}^{m}}{{\sum }_{j = 1}^{n} {s}_{j}^{m}} N = \frac{Average number of boarding people per day at i station}{Average number of boarding people per day in entire area} \times ( Predicted number of visitors in entire area ) \qquad ( 1 )$$

As above, the predicted number of people at each station in the area is obtained from the prediction value of the number of users in each area, and information is transferred to the route headcount prediction unit 13.

On the other hand, in a case where determination is made to use past population data in Step S3, the headcount distribution unit 12 acquires population data at each station during the past event from the location information DB 40 (Step S4), and distributes the prediction value of the number of users in each area into the predicted numbers of people at the respective stations in the area based on the numerical value regarding the scale of use of each of the stations and population data at each station during the past event (Step S5). The distribution herein is represented, for example, by the following expression using an arithmetic average. An example using a weighted average will be described below. In a case where n candidate stations are included in any area, the average numbers of boarding people per day at the respective stations are denoted as s^{m}₁, s^{m}₂, . . . , s^{m}ₙ, the prediction value of the number of visitors in the area is N people, and the number of visitors at the respective stations during a past event k are acquired as s^{p}₁ₖ, s^{p}₂ₖ, . . . , and s^{p}ₙₖ, the estimated number of event visitors s^{e}₁, s^{e}₂, . . . , and s^{e}ₙ at the respective stations are obtained by Equation (2) described below.

$$[ Equation 2 ]$$

$$\begin{matrix}{s}_{ik}^{m} = {s}_{ik}^{p} \frac{{\sum }_{j = 1}^{n} {s}_{j}^{m}}{{\sum }_{j = 1}^{n} {s}_{jk}^{p}} \\ = ( Number of visitors at i station in event k ) \\ \times \frac{Average number of boarding people per day in entire area}{Number of visitors in entire area in event k} \\ {\hat{s}}_{i}^{m} = \frac{{\sum }_{j = 1}^{l} {\hat{s}}_{ij}^{m} + {s}_{i}^{m}}{l + 1} \\ = \frac{Total of extrapolated value of visitors at i station in event + average number of boarding people per day at i station}{Number of past events l + 1} \\ {s}_{i}^{e} = \frac{{\hat{s}}_{i}^{m}}{{\sum }_{j = 1}^{n} {\hat{s}}_{j}^{m}} N\end{matrix} \qquad ( 2 )$$

As above, the predicted number of people at each station in the area is obtained from the past population data and the prediction value of the number of users in each area, and information is transferred to the route headcount prediction unit 13.

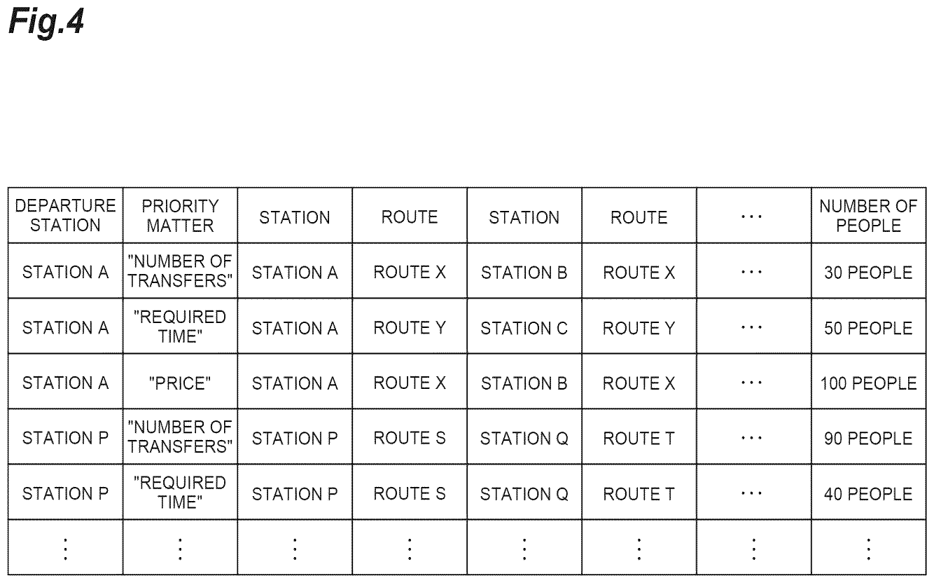

Next, the route headcount prediction unit 13 distributes the predicted number of people at each station in the area into the predicted numbers of people per route between each station and the event nearest station (Step S7). In more detail, the route headcount prediction unit 13 sets routes between each station and the event nearest station based on geographical route map information, operation information along a time axis, and a priority matter (for example, priority on the number of transfers, priority on required time, or priority on price) in the route search using an existing prescribed route search method (for example, Dijkstra's method), and distributes the number of users at each station estimated by the headcount distribution unit 12 for each of a plurality of set routes. For this reason, as illustrated in FIG. 4, a different route is set depending on the priority matter such as the number of transfers, required time, or price, and the predicted number of people (information at the right end in a table of FIG. 4) per set route is obtained. In this manner, the predicted number of people per route between each station and the event nearest station is obtained and is transferred to the use headcount prediction unit 14. Here, while an example where three kinds of the number of transfers, required time, and price are employed as the priority matters of route search has been described, the priority mater of route search is not limited thereto, and a method for route search is not limited to a specific method.

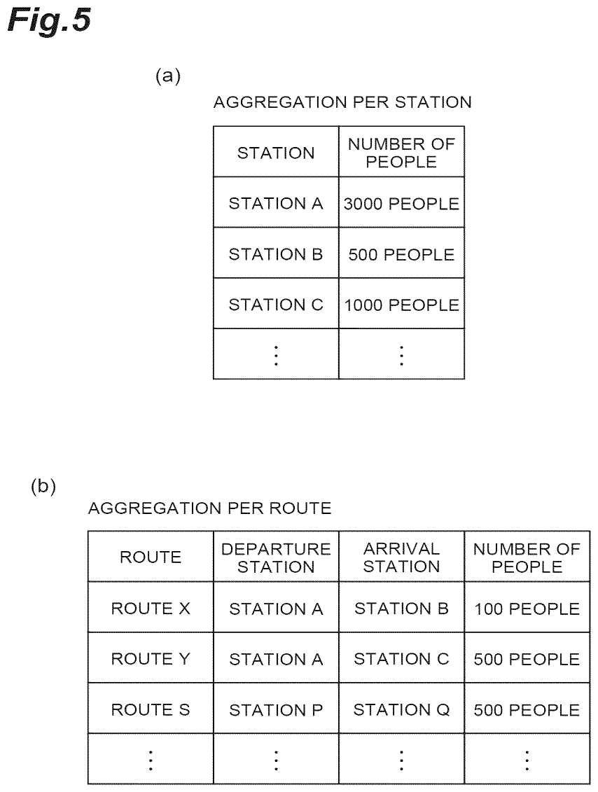

The use headcount prediction unit 14 predicts and outputs the number of users per event nearest station or per nearest route based on the predicted number of people per route (Step S8). For example, FIG. 5(a) illustrates an output data example of the number of users per event nearest station, and FIG. 5(b) illustrates an output data example of the number of users per nearest route. The “output” herein includes outputs in various forms such as display output on a display, print output to a printer, and data transmission to an external device.

Hereinafter, the effects of the above-described embodiment will be described.

With the above-described embodiment, it is possible to predict the number of users per event nearest station or per nearest route from the predicted number of people in each area pertaining to the visitors of the target event obtained in advance without using know-how of approximately how many people went toward each of the nearest stations to the event venue immediately after the end. With this, for example, even for events at newly opened event venues or new events, it is possible to predict the number of users per event nearest station or per nearest route with excellent accuracy. Furthermore, even for events with a long history of having been held, it is possible to predict the number of users per event nearest station or per nearest route with excellent accuracy according to the predicted number of people in each area pertaining to the visitors of the target event. That is, it is possible to predict traffic demand associated with holding of various events with excellent accuracy.

In a case where the headcount distribution unit 12 predicts the number of people at each station in the area based on the population data at each station during the past event, in addition to the numerical value regarding the scale of use of each of the stations in each area, it is possible to further improve the accuracy of headcount prediction by headcount prediction further taking into consideration the population data at each station during the past event.

In a case where the headcount distribution unit 12 predicts the number of people at each station in the area based on the population data at each station during the past event, in addition to the numerical value regarding the scale of use of each of the stations in each area, it is possible to perform headcount prediction by a method using a comparatively simple arithmetic average as described above.

As the route search algorithm, the algorithm that performs the route search based on the geographical route map information, the operation information along the time axis, and the priority matter in route search is used. With this, it is possible to predict “the predicted number of people per route between each station and the event nearest station” matching not only the geographical route map information but also actual railway operation information or a user's priority matter such as the operation information along the time axis and the priority matter (for example, the number of transfers, required time, and price) in the route search, and to further improve the accuracy of headcount prediction.

### (Modification Example of Distribution in Step S5 of FIG. 2)

In the distribution in Step S5 of FIG. 2, the following weighted average may be used instead of the arithmetic average. In a case where n candidate stations are included in any area, the average numbers of boarding people per day at the respective stations are denoted as s^{m}₁, s^{m}₂, . . . , and s^{m}ₙ, the prediction value of the number of visitors in the area is N people, and the numbers of visitors at the respective stations during a past event j are acquired as s^{p}₁ⱼ, s^{p}₂ⱼ, . . . , and s^{p}ₙⱼ, the estimated numbers of event visitors s^{e}₁, s^{e}₂, . . . , and s^{e}ₙ at the respective stations are obtained by Equation (3) described below.

$$[ Equation 3 ]$$

$$\begin{matrix}{\hat{s}}_{ij}^{m} = {s}_{ij}^{p} \frac{{\sum }_{h = 1}^{n} {s}_{h}^{m}}{{\sum }_{h = 1}^{n} {s}_{hj}^{p}} \\ = ( Number of visitors at i station in event j ) \\ \times \frac{Average number of boarding people per day in entire area}{Number of visitors in entire area in event j} \\ {\hat{s}}_{i}^{m} = \frac{{\sum }_{j = 1}^{l} {w}_{j} {\hat{s}}_{ij}^{m} + {w}_{0} {s}_{i}^{m}}{l + 1} \\ \frac{Weight \times number of people at i station in event 1 + weight \times number of people at i station in event 2 + … weight \times number of people at i station in event l + weight \times average number of people per day at i station}{Number of past events l + 1} \\ ( Here , \sum w = 1 ( i . e . a total value of weights is 1. ) ) \\ {s}_{i}^{e} = \frac{{\hat{s}}_{i}^{m}}{{\sum }_{j = 1}^{n} {\hat{s}}_{j}^{m}} N\end{matrix} \qquad ( 3 )$$

The above-described method for setting sets a weight to become greater as events have a greater number of users across the entire area, and sets a weight to be smaller as an event is smaller in the number of users. For example, in a case where “the number of users in an event 1” is A people” and “the number of users in an event 2 is B people”, in any area, if a weight w₀ regarding the average number of boarding people per day is denoted as x (here, x is 0<x≤1, in many cases, 0.5 is employed for x), the weights regarding the events 1 and 2 are set by Equation (4) described below.

$$[ Equation 4 ]$$

$$\begin{matrix}Weight {w}_{1} regarding event 1 = ( 1 - x ) \frac{A}{A + B} \\ Weight {w}_{2} regarding event 2 = ( 1 - x ) \frac{B}{A + B}\end{matrix} \qquad ( 4 )$$

A reason why a distribution by the number of users is not adopted regarding “the average number of boarding people per day” is that an effect for considering the number of users in an event is very little because w₀˜1, w₁˜0, w₂˜0 due to A <<C and B <<C (“C” means the average number of boarding people per day).

As in the above-described modification example, with the prediction based on the weighted average using the weight set to become greater as events have a greater number of users in the entire area, it is possible to perform the appropriate weighted average matching the number of users in the entire area and headcount prediction at each station in the area, and to further improve the accuracy of headcount prediction.

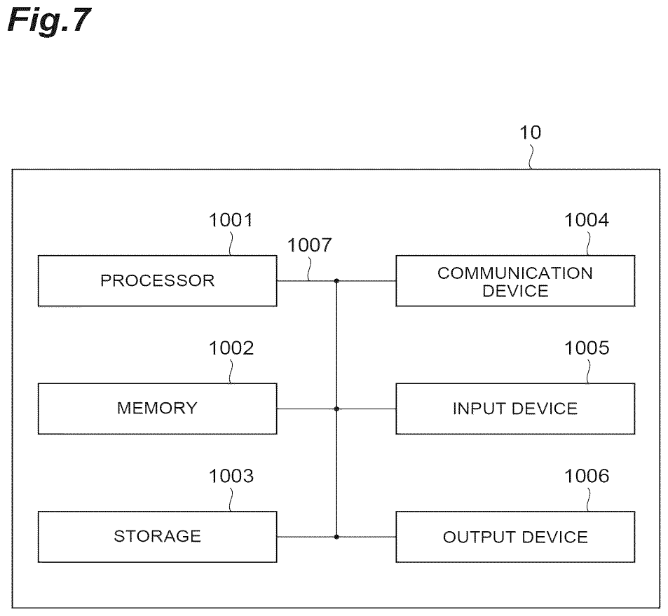

### (Description of Terms, Description of Hardware Configuration (FIG. 7), and the Like)

The block diagram used to describe the above-described embodiment and the modification examples illustrates blocks in units of functions. These functional blocks (constituent units) may be implemented in any combination of at least one of hardware and software. Also, the implementation method of each functional block is not particularly limited. That is, each functional block may be implemented using one device combined physically or logically or may be implemented by directly or indirectly connecting two or more devices separated physically or logically (for example, in a wired or wireless manner) and using the plurality of devices. The functional blocks may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

For example, the traffic demand prediction device in an embodiment of the present disclosure may function as a computer that executes processing in the present embodiment. FIG. 7 is a diagram illustrating a hardware configuration example of the traffic demand prediction device 10 according to the embodiment of the present disclosure. The above-described traffic demand prediction device 10 may be physically configured as a computer apparatus including a processor 1001, a memory 1002, a storage 1003, a communication device 1004, an input device 1005, an output device 1006, a bus 1007, and the like.

In the following description, the term “apparatus” can be replaced with a circuit, a device, a unit, or the like. The hardware configuration of the traffic demand prediction device 10 may be configured to include one or a plurality of devices among the devices illustrated in the drawing or may be configured without including part of the devices.

Each function in the traffic demand prediction device 10 is implemented by having the processor 1001 perform an arithmetic operation by reading prescribed software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit (CPU) including an interface with peripheral devices, a control device, an arithmetic device, a register, and the like.

The processor 1001 reads a program (program code), a software module, data, and the like from at least one of the storage 1003 and the communication device 1004 to the memory 1002 and executes various kinds of processing according to the program, the software module, data, and the like. As the program, a program that causes the computer to execute at least a part of the operations described in the above-described embodiment is used. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a wireless communication method according to an embodiment of the present invention.

The storage 1003 is a computer-readable recording medium, and may be configured with at least one of, for example, an optical disc such as a compact disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database including at least one of the memory 1002 and the storage 1003 or other appropriate mediums.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be integrated (for example, a touch panel).

The devices such as the processor 1001 and the memory 1002 are connected by the bus 1007 that is provided to communicate information. The bus 1007 may be configured using a single bus or may be used using different buses between devices.

Each aspect/embodiment described in the present disclosure may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

A process procedure, a sequence, a flowchart, and the like in each aspect/embodiment described in the present disclosure may be in a different order unless inconsistency arises. For example, for the method described in the present disclosure, elements of various steps are presented using an exemplary order, and the elements are not limited to the presented specific order.

Input or output information or the like may be stored in a specific place (for example, a memory) or may be managed using a management table. Information or the like to be input or output can be overwritten, updated, or additionally written. Output information or the like may be deleted. Input information or the like may be transmitted to another device.

The expression “based on” used in the present disclosure does not mean “based on only” unless otherwise described. In other words, the expression “based on” means both “based on only” and “based on at least”.

In the present disclosure, the terms “include”, “including”, and modifications thereof are used, these terms are intended to be comprehensive similarly to the term “comprising”. In addition, the term “or” used in the present disclosure is intended not to be an exclusive OR.

In the present disclosure, for example, in a case where an article such as “a”, “an”, or “the” in English is added through translation, the present disclosure may include a case where a noun following the article is of a plural form.

In the present disclosure, the term “A and B are different” may mean that “A and B are different from each other”. This term may mean that “each of A and B is different from C”. Terms “separate” and “coupled” may also be interpreted in a similar manner to “different”.

### REFERENCE SIGNS LIST

10: Traffic demand prediction device, 10A: Depot headcount prediction unit, 11: Candidate station selection unit, 12: Headcount distribution unit, 13: Route headcount prediction unit, 14: Use headcount prediction unit, 20: Terminal, 30: Station information database, 40: Location information database, 1001: Processor, 1002: Memory, 1003: Storage, 1004: Communication device, 1005: Input device, 1006: Output device, 1007: Bus

1. A traffic demand prediction device comprising:
a depot headcount prediction unit configured to predict a number of people per depot in an area from a predicted number of people obtained in advance for each of areas including at least one of a departure area and a return area of visitors to a target event based on at least a numerical value regarding a scale of use of each of depots in each of areas obtained in advance;
a route headcount prediction unit configured to predict a number of people per route between each depot in an area obtained by a route search algorithm and an event nearest depot from the number of people per depot in the area obtained by prediction in the depot headcount prediction unit; and
a use headcount prediction unit configured to predict a number of users per event nearest depot or per nearest route based on the number of people per route obtained by prediction in the route headcount prediction unit.

2. The traffic demand prediction device according to claim 1,
wherein the depot headcount prediction unit is configured to
predict the number of people per depot in the area based on population data at each depot during a past event in addition to the numerical value regarding the scale of use of each of the depots in each area.

3. The traffic demand prediction device according to claim 2,
wherein the depot headcount prediction unit is configured to
predict the number of people per depot in the area based on the numerical value regarding the scale of scale of each of the depots in each area and an arithmetic average of population data at each depot during the past event.

4. The traffic demand prediction device according to claim 2,
wherein the depot headcount prediction unit is configured to
predict the number of people per depot in the area from the numerical value regarding a scale of use of each of the depots in each area and population data at each depot during the past event based on a weighted average using a weight set to become greater as events have a greater number of users across an entire area.

5. The traffic demand prediction device according to claim 1,
wherein the route search algorithm is an algorithm that performs route search based on geographical route map information, operation information along a time axis, and priority matters in a route search.

6. The traffic demand prediction device according to claim 2,
wherein the route search algorithm is an algorithm that performs route search based on geographical route map information, operation information along a time axis, and priority matters in a route search.

7. The traffic demand prediction device according to claim 3,
wherein the route search algorithm is an algorithm that performs route search based on geographical route map information, operation information along a time axis, and priority matters in a route search.

8. The traffic demand prediction device according to claim 4,
wherein the route search algorithm is an algorithm that performs route search based on geographical route map information, operation information along a time axis, and priority matters in a route search.
